(19) United States
(12) Patent Application Publication
(10) Pub. No.: US 2015/0324099 A1
(43) Pub. Date: Nov. 12, 2015

(54) Connecting Current User Activities with Related Stored Media Collections

(71) Applicant: Microsoft Corporation, Redmond, WA (US)

(72) Inventor: John C. Tang, Palo Alto, CA (US)

(73) Assignee: Microsoft Corporation, Redmond, WA (US)

(21) Appl. No.: 14/272,461

(22) Filed: May 7, 2014

(51) Int. Cl. G06F 3/0484

(52) U.S. Cl. CPC G06F 3/04847; G06F 3/04842

(57) ABSTRACT

A Media Presentation System (MPS) identifies a user's current activity and then attempts to deliver one or more media items that are relevant to the user's current activity. In other words, those media items are determined to exhibit a pattern of previous user activity that matches the user's current activity. In one case, the MPS may determine that the user is engaged in a communication system with another user, using a communication system, such as a video communication system. In response, the MPS can present media items that pertain to the two users in the course of their communication session. For instance, at least some of the media items may have been captured in previous communication sessions between the two users.

### BACKGROUND

The current state of media-capture technology allows users to generate and store a large number of digital media items, such as photographs, videos, voice recordings, and so on. For example, a user may use his or her smartphone or wearable computing device to produce dozens of media items in the course of a single day. The user may then transfer these media items to a personal computer and/or a cloud storage service.

However, the proliferation of digital media makes it difficult for users to later retrieve media items of interest. In some cases, a user may simply forget that certain media items exist. In other cases, a user may have a vague recollection of generating the media items, but the user may have difficulty finding them again. In traditional practice, a user may manually organize collections of media items into meaningful folders. The user may then manually search through a directory of folders to find the desired media items. In addition, or alternatively, a user may add descriptive tags to the media items. The user may then use a keyword-based search interface to attempt to find media items of interest, that is, by finding media items having tags which match specified search terms. These approaches, however, offer poor user experience. For instance, these approaches are labor-intensive and cumbersome in nature, and are not always successful in retrieving the desired media items.

The above potential drawbacks in existing retrieval strategies are cited by way of illustration, not limitation; existing retrieval strategies may have further shortcomings.

### SUMMARY

A Media Presentation System (MPS) is described herein which receives and analyzes a plurality of media items pertaining to a user. The MPS then attempts to match the user's current activity with at least one pattern of previous user activity which is exhibited by the media items. The MPS then generates and delivers a user interface presentation to the user that conveys at least one media item that pertains to the pattern of previous user activity.

By virtue of the above approach, the user will receive media items that are relevant to his or her current circumstance, in a timely fashion, and without having to manually hunt for the media items, or without even having to remember that the media items exist. The media items may allow the user to enjoyably reminiscence about previous events that are relevant to his or her current situation.

Consider one concrete example. A user may visit her grandmother every year, around the same time, and in the same city. In a current visit, the MPS can detect that the user is engaged in a particular activity, namely, visiting her grandmother. The MPS can then determine that the current activity matches a pattern of prior conduct by the user—that is, visiting her grandmother on a yearly basis over the course of several prior years. The MPS can then deliver a collection of digital photographs to the user which captures her prior trips to visit her grandmother. The user may enjoy the retrospective provided by the collection, particularly since it coincides with her current activity.

The MPS can formulate the user interface presentation in different ways, such as a timeline-type format, a collage-type format, a time lapse animation sequence, and so on. In one particular case, the MPS can also present the user interface presentation in the context of an ongoing conversation between two more users, conducted via a communication system (such as a video communication system). The media items that are displayed may show snapshots or video clips taken from prior communication sessions between the two users, and/or other media items that are relevant to the two users. The media items in that context may facilitate conversation between the two users, as well as add to the enjoyment of the two users.

The above approach can be manifested in various types of systems, devices, components, methods, computer readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows one implementation of a Media Presentation System (MPS) which delivers media items that are assessed as being relevant to a user's current activity.

FIG. 2 shows a standalone implementation of the MPS.

FIG. 3 shows an implementation of the MPS that uses remote computing resources.

FIG. 4 shows an implementation of the MPS that involves interaction and integration with a video communication system.

FIG. 5 shows one implementation of a media analysis component, which is a module of the MPS.

FIG. 6 shows one implementation of a presentation processing component, which is another module of the MPS.

FIG. 7-11 show illustrative user interface presentations that may be generated by the presentation processing component.

FIG. 12 is a process that describes one manner of operation of the MPS.

FIG. 13 is a process that describes one manner of operation of the media analysis component.

FIG. 14 is a process that describes the integration of the MPS into a communication system.

FIG. 15 shows illustrative computing functionality that can be used to implement any aspect of the features shown in the foregoing drawings.

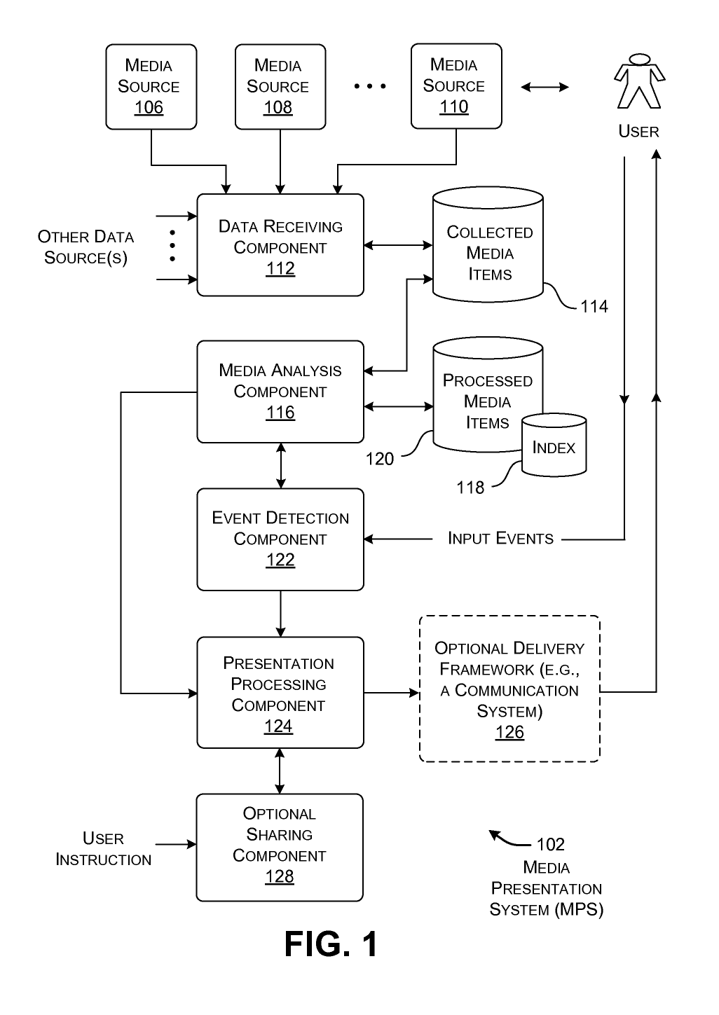

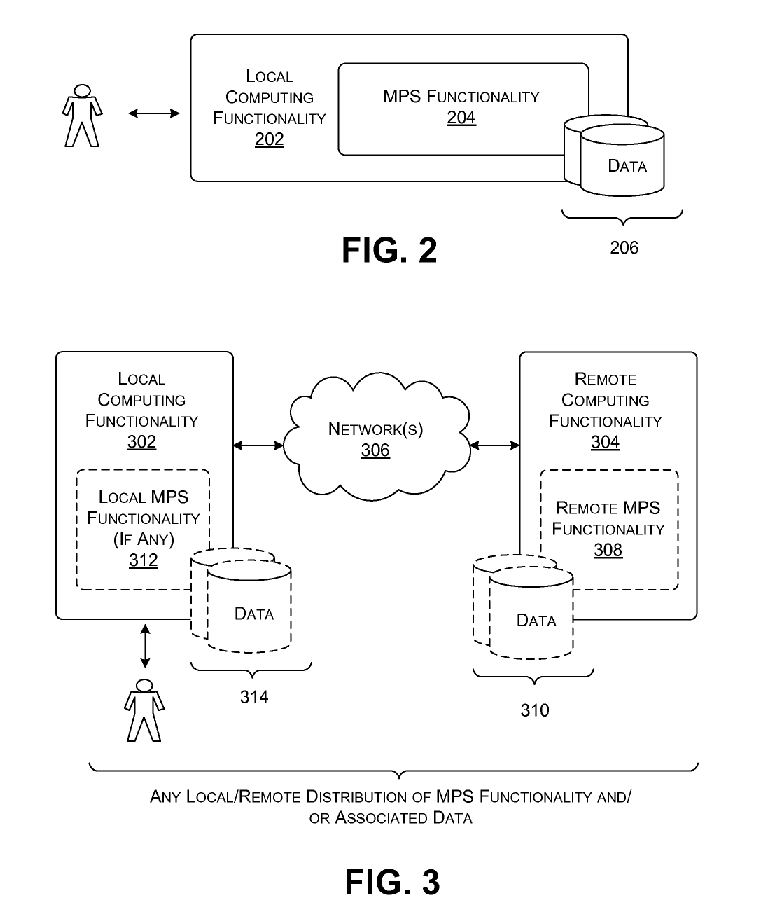

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A provides an overview of a Media Presentation System (MPS). Section B sets forth processes which describe one manner of operation of the MPS of Section A. Section C describes illustrative computing functionality that can be used to implement any aspect of the features described in Sections A and B.

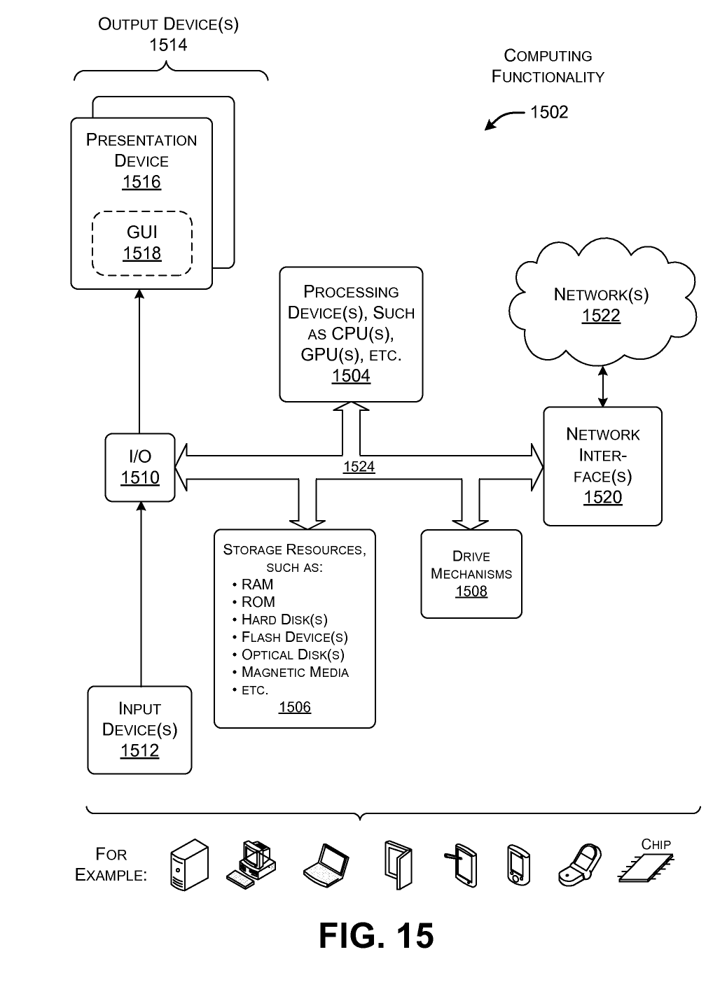

As a preliminary matter, some of the figures describe concepts in the context of one or more structural components, variously referred to as functionality, modules, features, elements, etc. The various components shown in the figures can be implemented in any manner by any physical and tangible mechanisms, for instance, by software running on computer equipment, hardware (e.g., chip-implemented logic functionality), etc., and/or any combination thereof. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. FIG. 15, to be described in turn, provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner by any physical and tangible mechanisms, for instance, by software running on computer equipment, hardware (e.g., chip-implemented logic functionality), etc., and/or any combination thereof.

As to terminology, the phrase “configured to” encompasses any way that any kind of physical and tangible functionality can be constructed to perform an identified operation. The functionality can be configured to perform an operation using, for instance, software running on computer equipment, hardware (e.g., chip-implemented logic functionality), etc., and/or any combination thereof.

The term “logic” encompasses any physical and tangible functionality for performing a task. For instance, each operation illustrated in the flowcharts corresponds to a logic component for performing that operation. An operation can be performed using, for instance, software running on computer equipment, hardware (e.g., chip-implemented logic functionality), etc., and/or any combination thereof. When implemented by computing equipment, a logic component represents an electrical component that is a physical part of the computing system, however implemented.

The following explanation may identify one or more features as “optional.” This type of statement is not to be interpreted as an exhaustive indication of features that may be considered optional; that is, other features can be considered as optional, although not expressly identified in the text. Further, any description of a single entity is not intended to preclude the use of plural such entities; similarly, a description of plural entities is not intended to preclude the use of a single entity. Finally, the terms “exemplary” or “illustrative” refer to one implementation among potentially many implementations.

A. Overview of the Media Presentation System

FIG. 1 shows one implementation of a Media Presentation System (MPS) 102. The MPS 102 collects media items pertaining to a user, analyzes the media items, and then delivers selected media items that are determined to be relevant to the user's current activity.

The media items can include any type of content, or any combination of digital content types. For example, a media item can include any combination of: static image content; video content; audio content; graphic content (e.g., produced by a game application, simulator, etc.); textual content, and so on. A user may use one or more media sources (106, 108, . . . , 110) to produce the media items. For example, the user may use a digital camera to generate digital photographs. The user may use a video camera to produce digital videos. The user may use one or more audio recording devices to produce audio items. The user may use a game console to produce graphical items, and so on. In some cases, a media source may represent a device that is designed for the main purpose of recording digital media. A digital camera is one such type of device. In other cases, a media source may correspond to a device that performs multiple functions, one of which corresponds to recording digital media. A smartphone is an example of one such device.

In other cases, a media source may represent an archive data store at which the user stores media items, such as a cloud-based data store. In other cases, a media source may correspond to a user's social network profile or the like at which the user maintains media items, and so on. Generally, the assumption here is that the user creates his or her media items, e.g., by taking his or her own digital photographs. But in other cases, at least some of the media items may be selected by the user, but produced by others.

A data receiving component 112 receives media items from the various media sources (106, 108, . . . 110). The data receiving component 112 can collect media items using a push-based approach, a pull-based approach, or some combination thereof. In a push-based approach, a user may expressly and manually upload media items to the data receiving component 112. Or a media source may automatically initiate the transfer of media items to the data receiving component 112. In a pull-based approach, the data receiving component 112 may poll the various media sources (106, 108, . . . 110) and collect any new media items they may provide.

FIG. 1 also indicates that the data receiving component 112 may receive supplemental data from one or more other sources. Such data may pertain to the collected media items, but may not constitute media items per se. For example, the data receiving component 112 can receive textual metadata information that describes the media items that have been collected, such as by using keywords, etc. In another case, the data receiving component 112 can receive user ID information which identifies users who may appear in the media items, and so on. The data receiving component 112 can receive the ID information from any source which maintains this data, such as a communication system that maintains ID information for its respective Users.

The data receiving component 112 may store the media items and the supplemental data in a data store 114. More specifically, the data store 114 can store media items for a plurality of users, not just the single user depicted in FIG. 1. The data store 114 may represent a remote data store (with respect to each user) and/or plural local data stores (with respect to each user). Note that, in all cases described herein, the figures and the text describe each data store in the singular, that is, as a single entity; but this manner of reference is intended to encompass the case in which the data store is implemented by two or more underlying physical storage devices, provided at a single site, or distributed over two or more sites.

A media analysis component 116 analyzes the media items to provide an analysis result. The following description will provide a detailed explanation of one manner of operation of the media analysis component 116. By way of overview, the media analysis component 116 can first filter out low-quality media items and redundant media items. The media analysis component 116 can then perform content analysis on each media item to determine the characteristics of the media item. The media analysis component 116 can then update an index provided in a data store 118 to reflect the results of its analysis. The index serves as a mechanism that can be used to later retrieve media items that have desired characteristics. The media analysis component 116 can also store a corpus of processed media items in a data store 120. The processed media items may correspond to the original set of collected media items, minus the media items that have been assessed as having low quality and/or being redundant. The media analysis component 116 can also optionally transform some of the original media items in any manner to produce the processed media items, such as performing cropping, resizing, etc. on the original media items.

An event detection component 122 detects an input event. The input event reflects a current activity of the user. Here, the term “current activity” is intended to have broad meaning. The current activity generally refers to behavior by the user that is centered on or associated with the current time, but does not necessarily occur at the current time. For example, the current activity may describe behavior that has occurred, is presently occurring, or is about to occur, with respect to a current point in time. Further, the current activity may describe a wide variety of actions, such as performing a task, attending an event, visiting a location, and so on.

For example, in one case, an input event may indicate that the user is about to participate in an event that is scheduled to occur on a specified future date, or is currently taking part in the event on the specified date, or has recently taken part in the event. The event detection component 122 can detect this type of event based primarily on a determination of the current date in relation to the specified date. For example, the event detection component 122 can generate an input event when the calendar date reaches December 23^{rd}, based on the presumption that the user may be about to engage in, holiday-related activities.

In another case, an input event may indicate that the user is about to visit a particular location. Or the input event may indicate that the user is currently visiting that location, or has recently visited the location. The event detection component 122 can detect this type of event in different ways, such by identifying geographical reference coordinates that are associated with media items that the user is currently uploading. In one case, the user may be actually present at the identified location at the time he or she has uploaded the media items. In another case, the user may no longer be at that site. In addition, or alternatively, the event detection component 122 can determine the location of the user via one or more location determination mechanisms that are incorporated into the user's mobile computing device or which are otherwise accessible to these devices, such as satellite-based location-determination services, triangulation mechanisms, dead-reckoning mechanisms, proximity-to-signal-source-based mechanisms, etc. The motion of the computing device (as assessed by accelerometers, gyroscopes, etc.) may also be relevant to the user's current activity.

In another case, an input event may indicate that the user is performing a specific activity, where that activity is not necessarily tied to a telltale location or time. For example, the input event may indicate that the user is currently playing a particular sport. The event detection component 122 can detect such an activity in different ways, such as by receiving a media item from the user that depicts the activity, and leveraging the media analysis component 116 to recognize the activity that is taking place in the media item. The event detection component 122 can alternatively, or in addition, detect the location of the user in the above-described manner, e.g., by comparing objects that appear in the user's recently uploaded media items with telltale landmark objects, associated with particular places.

In another case, an input event may indicate that the user is currently interacting with another user via a communication system of any type, such as a video communication system, an instant messaging system, an Email system, and so on. Or the input event may indicate that the user is preparing to take part in a communication session, or has just taken part in such a session. The event detection component 122 can detect this type of input event based on information supplied by the communication system. The event detection component 122 can also receive information from the communication system which reveals the identities of the people involved in the communication session.

In another case, an input event may indicate that the user is currently performing a particular activity in an online space, by himself or herself, or with another person. For example, the user may be currently shopping for a certain item, reading a particular news article on a particular topic, performing a financial transaction, playing a game, and so on. The event detection component 122 can detect the above types of actions, with the appropriate permission of the user, based on information exchanged between the user and one or more online services.

The above-described input events are cited by way of example, not limitation.

A presentation processing component 124 performs two functions. It first determines whether the current presumed user activity, reflected by the input event(s), matches a previous pattern of user activity, as exhibited by the media items that have been processed by the media analysis component 116. These media items are referred to below as relevant media items. If such a pattern is detected, then the presentation processing component 124 generates a user interface presentation that conveys one or more of the relevant media items to the user. If there are no relevant media items, then the presentation processing component 124 will refrain from generating a user interface presentation. Alternatively, in the absence of relevant media items, the presentation processing component 124 may present other default content, such as randomly selected photo items drawn from a user's personal archive of items, etc. Or the presentation processing component 124 can make a low confidence guess as to the user's current circumstance, and present media items that match that guess.

The description will later explain in greater detail how the presentation processing component 124 performs the above two tasks. By way of overview, with respect to the first task, the presentation processing component 124 attempts to find one or more previously-captured (historical) media items that have one or more characteristics in common with the user's current presumed activity.

Further, the presentation processing component 124 may choose only those matching patterns of previous user activity that represent significant events, from the standpoint of the user, based on one or more significance-based considerations. For example, the presentation processing component 124 may determine that the user is currently riding the bus to her work. The presentation processing component 124 may further determine that the user's current activity matches a previous pattern of conduct exhibited by the user—namely, repeatedly riding the bus to work. However, based on one configuration of the MPS 102, the presentation processing component 124 may label this previous pattern of conduct as insignificant, and thus refrain from generating a user interface presentation under this circumstance. That is, the presentation processing component 124 makes the rebuttable/correctable assumption that an event that is extremely common is also uninteresting.

A delivery framework 126, while not considered part of the MPS 102 itself, may deliver the user interface presentation, generated by the presentation processing component 124, to at least the user. In one case, the delivery framework 126 may send a notification to the user's computing device (e.g., which may correspond to a tablet-type device, a smartphone, etc.). The user may then affirmatively respond to an invitation provided by the notification to invoke the media experience provided by the MPS 102. In another case, the delivery framework 126 corresponds to an Email system, or the like. For example, the delivery framework 126 can include the relevant media items as an attachment to an Email. In another case, the delivery framework 126 can provide a link which the user can activate to view the relevant media items, and so on.

In another case, the delivery framework 126 can integrate the relevant media items into a more encompassing user interface presentation provided by any communication system, such as a video communication system, an instant messaging communication system, and so on. For example, in the context of a video communication system (such as the Skype™ communication system provided by Microsoft® Corporation of Redmond, Wash.), the overall user interface presentation may include a first portion devoted to displaying a real-time picture of a first and second user who are communicating with each other, or just the remote user (from the vantage point of a local user who is interacting with the user interface presentation). The user interface presentation may devote a second portion for displaying related media items that pertain to the first user and/or the second user. For example, in one particular case, the relevant media items may correspond to snapshots or video clips extracted from previous communication sessions between the first user and the second user.

In another case, the MPS 102 can incorporate the user interface presentation into a screensaver or the like, presented by the user's computing device. In another case, the MPS 102 can incorporate the user interface presentation into a tile or widget, etc. The user's computing device can present the tile or widget in any display context. Furthermore, this tile or widget may give a preview of the full user interface presentation, which may entice the user to select it to view the full presentation.

Finally, an optional sharing component 128 may allow the user (who receives the user interface presentation) to share the relevant media items with one or more other users. For example, the user may interact with the sharing component 128 to post the collection of relevant media items to the user' social network page. Or the user may interact with the sharing component 128 to send the relevant media items to another person (such as the user's spouse or friend), particularly in those cases in which the media items also pertain to the other person. For example, the user may send the relevant media items via an Email system, a video communication system, etc. In one case, the relevant media items contain a visual indicator (e.g., a digital watermark or the like) which indicates that they originated from a service associated with the MPS 102.

In another case, any other user, with the permission of the user who owns the digital media items, may subscribe to the collections of relevant items that are provided to the user. For example, the user's friend may subscribe to the user's collections of media items, generated by the MPS 102, especially when the friend is included in the collection. In response to the subscription, the MPS 102 will deliver any collection to both the user and his or her friend.

Other implementations of the MPS 102 can omit one or more features described above, and illustrated in FIG. 1. In addition, or alternatively, other implementations of the MPS 102 can introduce additional features, not shown in FIG. 1.

Advancing to FIG. 2, this figure shows a local stand-alone implementation of the MPS 102 of FIG. 1. In this case, local computing functionality 202 provides local MPS functionality 204 which, together with one or more local data stores 206, implements all aspects of the MPS 102 described above. The local computing functionality 202 may correspond to any computing device, such as a workstation computing device, a set-top box, a game console, a laptop computing device, a tablet-type computing device, a smartphone or other kind of wireless telephone, a personal digital assistant device, a music-playing device, a book-reader device, a wearable computing device, and so on.

FIG. 3 shows another implementation of the MPS 102 of FIG. 1. In this scenario, local computing functionality 302 is coupled to remote computing functionality 304 via one or more networks 306. In one case, the remote computing functionality 304 includes remote MPS functionality 308 which implements all aspects of the MPS 102, in conjunction with one or more remote data stores 310. A user may interact with the remote computing functionality 304 using the local computing functionality 302 via the network(s) 306. For example, the user may upload media items to the remote computing functionality 304 using the local computing functionality 302. Further, the user may receive the user interface presentation delivered by the remote computing functionality 304 via the local computing functionality 302.

In another case, the functions performed by the MPS 102 are distributed between the remote computing functionality 304 and local computing functionality 302. Local MPS functionality 312 runs on the local computing functionality 302, in conjunction with one or more local data stores 314. For example, the local MPS functionality 312 may perform some media analysis functions, while the remote MPS functionality 308 may perform other media analysis functions. For instance, the local computing functionality 302 may rely on the remote computing functionality 304 to perform image analysis functions that are resource-intensive in nature, and are therefore more efficiently performed by the remote computing functionality 304 (which may have more robust computing resources compared to the local computing functionality 302).

The local computing functionality 302 may correspond to any computing device described above with reference to FIG. 2. The remote computing functionality 304 may correspond to one or more servers and associated data stores, provided at a single site or distributed among two or more sites. The network(s) 306 may correspond to a local area network, a wide area network (e.g., the Internet), point-to-point communication links, etc. or any combination thereof.

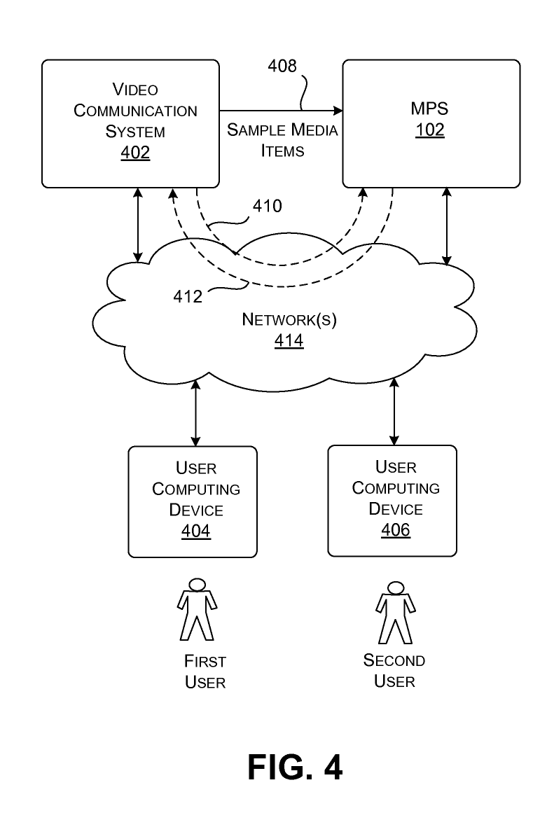

FIG. 4 shows a particular application of the MPS 102. Here, a video communication system 402 provides a video communication service to at least a first user and a second user. The first user interacts with the video communication system via a first computing device 404, while the second user interacts with the video communication system 402 via a second computing device 406.

The MPS 102 may interact with the video communication system 402 in delivering relevant media items to the user. For example, in interaction path 408, the MPS 102 may receive media items from the video communication system 402. Those media items may correspond to snapshots and/or video clips of the first user and the second user over a span of time, and over several video communication sessions. The MPS 102 may also independently receive media items uploaded by the first user and/or the second user, which do not necessarily originate from prior video sessions.

In the interaction path 410, the video communication session may send call setup data to the MPS 102. The call setup data indicates that the first user and the second user have initiated a current communication session. More specifically, the call setup data can identify the first user and the second user based on user credentials submitted by the first user and the second user, e.g., in the course of setting up the communication session.

The call setup data may also constitute an input event that triggers the MPS 102 to generate a user interface presentation. That is, in response to the input event, the MPS 102 generates one or more relevant media items. In an interactive path 412, the MPS 102 delivers the relevant media items to the video communication system, which, in turn, integrates the relevant media items into the overall user interface presentation that it provides to the first user and the second user. One or more networks 414 communicatively couple the above-identified components together.

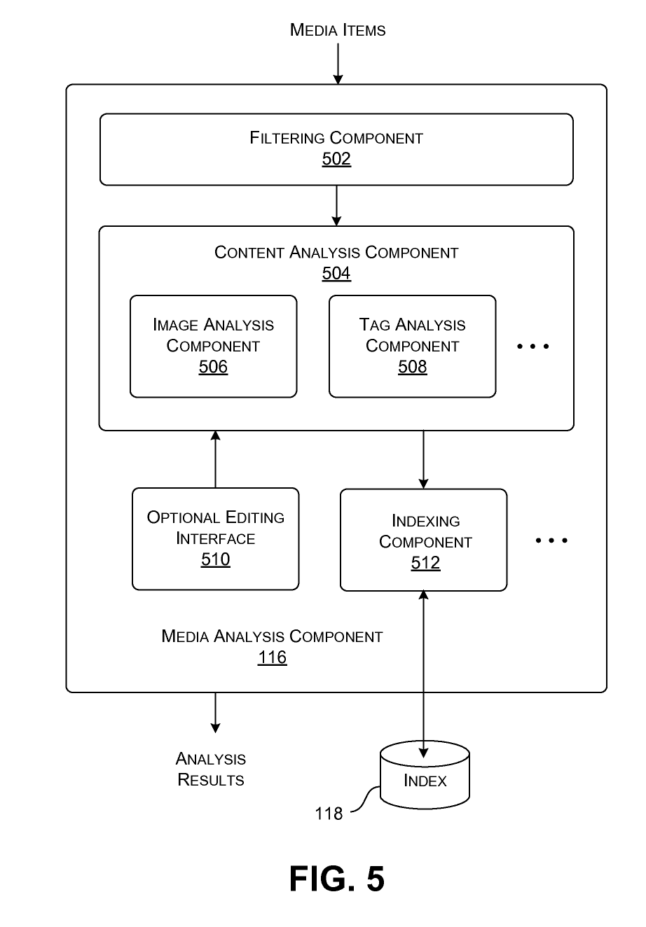

FIG. 5 shows one implementation of the media analysis component 116. Overall, as previously described, the media analysis component 116 determines the characteristics of the media items that have been uploaded to the MPS 102. In one case, the media analysis component 116 can perform all of its analysis immediately, whenever new media items are received. In another case, the media analysis component 116 can perform its operations in a resource-dependent manner, so as not to overwhelm the resources of the computing device(s) which implement the media analysis component 116. For example, the media analysis component 116 may perform its analysis during idle times, when the user is not interacting with the computing device(s) and when the computing device(s) are not otherwise performing resource-intensive tasks. In addition, the media analysis component 116 can perform its operations in a staggered manner. For example, the media analysis component 116 can apply successive phases of image analysis on the media items, incrementally identifying additional characteristics of the media items.

A filtering component 502 may perform processing on an original set of media items to remove noise from the set of media items. For example, the filtering component 502 can apply known blur detection techniques to identify and remove media items that exhibit blurry images. In addition, or alternatively, the filtering component 502 can apply known frame analysis techniques to identify and remove any media item in which a presumed focal point of interest is not well centered within the frame.

In addition, or alternatively, the filtering component 502 can apply known image analysis techniques to reduce the number of similar media items in the set of original media items. For example, the filtering component 502 can extract image features associated with each of the media items in the set of original media items. The filtering component 502 may then use the image features to cluster the media items into groups of having presumed similar content. The filtering component 502 can then use any technique (such as a random technique) to choose one or more representative media items from each cluster.

A content analysis component 504 analyzes the content of the media items which survive the filtering operation performed by the filtering component 502. More specifically, an image analysis component 506 can perform image-related analysis on the media items (assuming, that is, that the media items have image or video content). A tag analysis component 508 may provide analysis on any supplemental information which accompanies the media items, such as textual metadata or the like. Although not shown, the content analysis component 504 can include yet other content analysis modules, such as an audio analysis component which analyzes information extracted from audio media items.

The image analysis component 506, in turn, can encompass plural techniques for analyzing the image content of the media items. For example, the image analysis component 506 can use known face recognition technology to determine the presence of human faces in the media items. The image analysis component 506 can also use the face recognition technology to identify the number of people present in each media item, if any.

Further, the image analysis component 506 may provide a database of telltale objects that may appear in the media items, and which users typically regard as significant, and/or which a particular user regards as significant. For example, one such object may correspond to a birthday cake. Another such object may correspond to a Christmas tree, and so on. The image analysis component 506 can then compare the image content of the media items with the objects to determine whether the media items contain any of these objects. The image analysis component 506 can leverage the same technique to determine the identities of people who appear in the media items, e.g., by comparing the media items to reference images or feature signatures associated with people having established identities.

Further, the image analysis component 506 may compare the media items with a corpus of other reference media items that have been tagged by one or more other users, e.g., using a crowdsourcing technique or the like. For example, one such reference media item may include metadata which identifies the media item as a picture of the Fish Market, which is a well-known tourist attraction in the city of Seattle. Upon finding a match between a newly received media item and at least one reference media item, the image analysis component 506 may annotate the new media items with the same tags as the reference media item. That is, upon finding a new media item that resembles a previous media item of the Fish Market, the image analysis component 506 may annotate the new media item with a tag that indicates that it pertains to the Fish Market.

The image analysis component 506 may perform yet other image analysis techniques to analyze the content of the media items. The above techniques are cited by way of example, not limitation.

The tag analysis component 508 can perform any linguistic analysis on the supplemental information that is associated with the media items. For example, the tag analysis component 508 can select media items that are tagged with keywords that are regarded as particularly noteworthy, such as the words “birthday,” “anniversary,” “vacation,” and so on. The tag analysis component 508 can perform other linguistic analysis tasks, such as by expanding the supplemental information to include synonyms, etc. The tag analysis component 508 can also perform any techniques to extract the underlying meaning of the supplemental information, such as Latent Semantic Analysis (LSA), etc.

An optional editing interface 510 may allow a user to manually assist the content analysis component 504 in interpreting the media items. For example, the user may use the editing interface 510 to indicate that a particular media item includes a particular person. In one case, the content analysis component 504 may prompt the user for the above type of assistance whenever it cannot automatically interpret a media item with a sufficient degree of confidence.

An indexing component 512 updates an index provided in a data store 118 based on the characteristics of the media items identified by the content analysis component 504. For example, the index may correspond to an inverted index. The inverted index may identify different characteristics that the media items may potentially possess. For each such characteristic, the index may then identify the media items that actually possess that characteristic. For example, one characteristic may correspond to a birthday cake. The inverted index may identify those media items that have been determined to include image content that resembles a birthday cake. The indexing component 512 updates the index by establishing links between the media items analyzed by the content analysis component 504 and the identified characteristics of those media items.

As a result of its analysis, the media analysis component 116 produces analysis results. The analysis results may reflect, in part, the updated indexing information stored in the index.

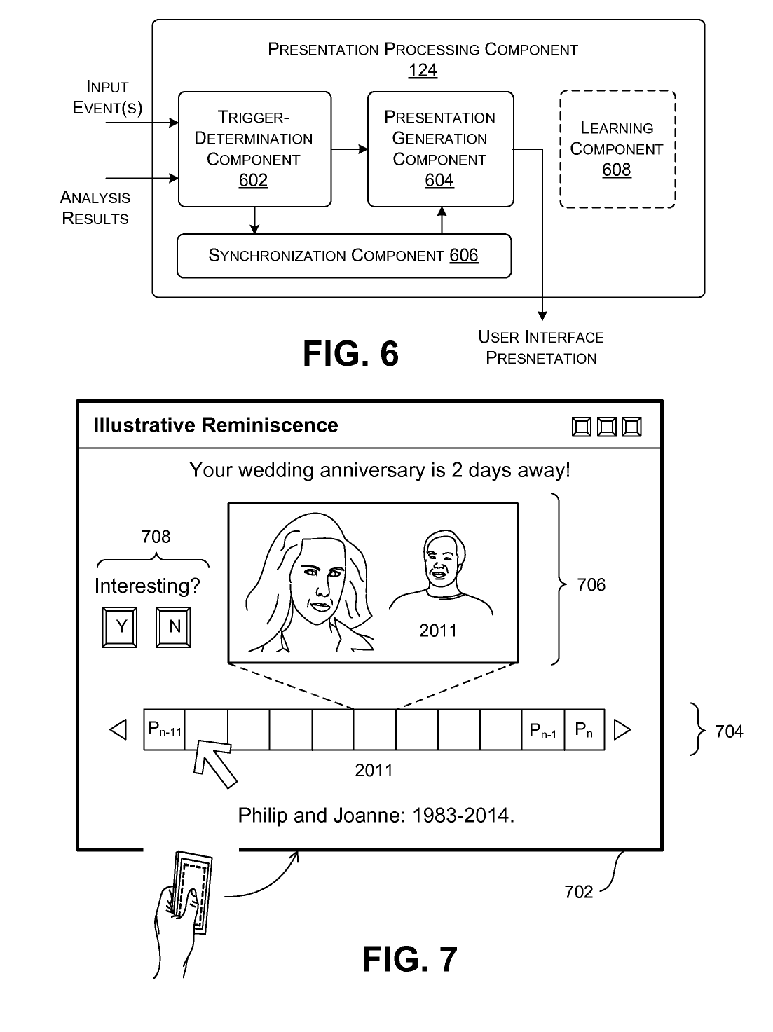

FIG. 6 shows one implementation of the presentation processing component 124. The presentation processing component 124 includes a trigger-determination component 602 which determines whether it is appropriate to serve one or more related media items to the user. The trigger-determination component 602 can make that decision based on the input event(s), together with the analysis results provided by the media analysis component 116, and/or other factors.

In one implementation, for instance, the trigger-determination component 602 can identify one or more characteristics of an input event. The trigger-determination component 602 can then use those characteristics as lookup keys to find the media items (if any) which share one or more of those characteristics. The trigger-determination component 602 may use the index to perform this task. A group of media items that share the identified characteristics correlates to a previous pattern of user activity. For example, assume that the input event corresponds to a cruise that a couple takes on their wedding anniversary. A group of media items that capture this event from prior years establishes a prior pattern of user activity for that couple.

The trigger-determination component 602 can also apply one or more significance-based considerations to determine whether the input event is significant to the user, and therefore warrants delivery of related media items to the user. In one case, for example, the trigger-determination component 602 can identify the number of media items that match the input event. The trigger-determination component 602 may conclude that a very small number of media items evinces a not-yet-significant event, as the identified media items fail to establish a meaningful pattern at this point in time. On the opposite extreme, the trigger-determination component 602 may conclude that a very large number of matching media items indicates that the items may also be insignificant, as their very ordinariness may suggest that the events will not interest the user. However, such configuration choices are application-specific in nature. In other cases, for instance, the trigger-determination component 602 may choose to deliver related media items predicated on only a small number of matching media items.

In addition, or alternatively, the trigger-determination component 602 can attach different weights to different characteristics. For example, an administrator and/or a user may establish, in advance, the events and objects that are considered particularly significant, such as birthdays, anniversaries, annual vacations, etc. An administrator and/or user may also establish, in advance, that any media item that includes two or more people is potentially significant. Moreover, an administrator and/or user can define the events and objects that considered particularly insignificant, such as trips to the supermarket. In application, the trigger-determination component 602 can indicate that an event is significant if it has one or more characteristics that have been labeled as significant.

A user can specify significance-related information in any manner. For example, the user may explicitly specify that information via a setup/configuration page provided by the MPS 102. In addition, or alternatively, the MPS 102 can extract such information from other sources that pertain to the user, such as the user's calendar system, social network profile, and on. In addition, or alternatively, the trigger-determination component 602 may leverage crowdsourcing resources to identify significant and insignificant events and objects, and hence to establish the weights assigned to these features.

More generally stated, the trigger-determination component 602 can apply any computation(s) to assess the relevance of a candidate media item, with respect to the user's current circumstance. For example, the trigger-determination component 602 may apply any discrete mathematical equation(s), any algorithm(s), a linear or non-linear model of any type produced by a machine-learning process, an expert system, any clustering-based algorithm(s), and so on, or any combination thereof. For example, in one non-limiting case, the trigger-determination component 602 can generate a relevance score based on a linear combination of weighted factors, including any of the factors described above, including priorities expressed by the system, the user, plural users, etc.

Further note that, in some situations, the trigger-determination component 602 may use any of the above techniques to match the user's present circumstance to plural different patterns of conduct that are happening at the same time, along with plural sets of associated media items. For example, the user may be performing two significant telltale activities at generally the same time, such as celebrating a birthday at a favorite vacation location (where the birthday celebration constitutes one significant event, regardless of where it occurs, and the visit to the vacation location constitutes another significant event, regardless of when and why that visit occurs). The trigger-determination component 602 can use any of the above techniques (and factors) to rank the relevance of the matching media items. In addition, in one implementation, the trigger-determination component 602 can apply one or more factors to ensure that the selected collection of media items forms a cohesive theme or narrative; in other cases, the trigger-determination component 602 may accommodate a more varied collection of media items that matches different patterns associated with the user's present circumstance.

A presentation generation component 604 generates a user interface presentation, when prompted to do so by the trigger-determination component 602. The user interface presentation shows one or more media items that are determined to be related to the user's current activity.

A synchronization component 606 synchronizes a collection of video media items that have been determined to pertain to the same pattern of user activity. For example, the synchronization component 606 can identify a common reference event in each of the video media items, such as the start of the event. The synchronization component 606 can then configure the group of video media items such that they simultaneously run, starting from the reference event. In addition, or alternatively, the synchronization component 606 can match up the frames of a first video media item with the frames of a second video media item, e.g., based on an analysis of similar content in those frames. The synchronization component 606 can use the resultant comparison results to further synchronize the video media items, e.g., such that similar frames are controlled to play back at the same times.

A learning component 608 receives feedback information from the user. Based on that information, the learning component 608 modifies the operation of the presentation processing component 124, and/or any other component of the MPS 102. For example, the user may use various techniques to evaluate the output of the MPS 102, such as by indicating whether the media items presented to him or her are interesting. The learning component 608 can use those evaluation results to promote the future generation of media items that the user likes, and to discourage the generation of media items that the user does not like. The learning component 608 can also take into account the likes and dislikes of other users, based on the presumption that general trends in user preferences may apply to the particular user under consideration.

In one particular case, the learning component 608 can specifically use feedback from the user to adjust the weight that it associated with different features, and/or by adjusting other tunable parameters. For example, assume that the user repeatedly indicates that he or she is not interested in media items having Christmas trees, despite the fact that this feature may have had a high original default weight. In response, the learning component 608 can lower the relevance weight of the Christmas tree feature. The user will thereafter see fewer or no media items having Christmas trees. In other cases, the MPS 102 can use models produced by machine learning techniques to perform its functions. The MPS 102 can use the feedback provided by the user to dynamically retrain its models.

FIGS. 7-11 show various user interface presentations that the presentation processing component 124 may generate. All aspects of these user interface presentations are illustrative, rather than limiting. The aspects include the selection of user interface elements, the arrangement of the elements, the visual appearance of the elements, the behavior of the elements, and so on.

Starting with FIG. 7, this figure shows a user interface presentation 702 that is generated in response to an input event that indicates that the user's wedding anniversary is near. Alternatively, or in addition, the presentation processing component 124 can generate the user interface presentation 702 on the specific date of the user's anniversary, and/or shortly after the anniversary.

The user interface presentation 702 displays a collection of media items that were taken on previous instances of the anniversary date. Here, the user interface presentation 702 arranges the collection of media items using a timeline format. That is, a timeline 704 spans a period of time that begins on the user's wedding day and ends on the current date. The user has selected one such media item 706 within the timeline 704, e.g., corresponding to an instance of the anniversary that occurred in the year 2011. A feedback control mechanism 708 allows the user to evaluate whether the particular media item is interesting or not interesting, or whether the entire collection is interesting or not interesting. One or more components of the MPS 102 can modify their manner of operation based on the feedback information provided via such a feedback control mechanism 708.

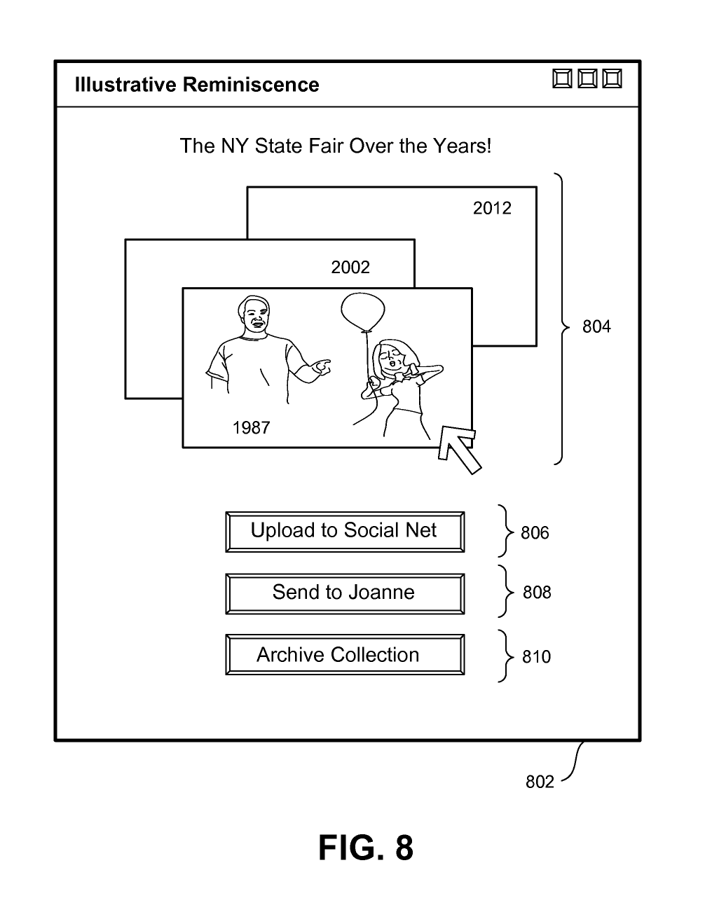

FIG. 8 shows a user interface presentation 802 that is generated in response to an input event that indicates that the user is currently visiting a particular location, corresponding to the site at which the State of New York hosts an annual fair (i.e., Syracuse). Or the input event may indicate that the user has just visited that site, or is about to visit that site. For example, the presentation processing component 124 may generate the user interface presentation 802 when the user uploads a set of new media items that were taken at the site, as revealed by geographic reference coordinates associated with the media items. A digital camera may automatically add those geographic tags; alternatively, or in addition, the user may manually produce those tags, e.g., by manually tagging the collection with the tag “State Fair,” or the location of that event (i.e., “Syracuse”).

The user interface presentation 802 displays a collection of media items that were taken on previous annual visits to the site in question. Here, the user interface presentation 802 arranges the collection of media items in a collage 804, but the user interface presentation 802 could use any other format (such as a timeline format) to convey the same collection.

The user interface presentation 802 may also include one or more control mechanisms. A first control mechanism 806 allows the user to instruct the MPS 102 to upload the collection of media items to a social network service. A second control mechanism 808 allows the user to instruct the MPS 102 to send the collection of media items to specified person, such as a particular person (“Joanne”) who also is prominently featured in the media items, e.g., corresponding to the user's spouse. Alternatively, the user interface presentation 802 may include a control mechanism that allows the user to share the collection of media items with any specified person, as manually specified by the user. A third control mechanism 810 allows the user to store the collection of media items in an archive data store. The MPS 102 can treat the user's interaction with any of the above-described control mechanisms (806, 808, 810, etc.) as an implicit approval of the collection of media items presented by the user interface presentation 802. The MPS 102 may use such actions as feedback information to improve the operation of one or more of its components. The user interface presentation may also include the explicit feedback control mechanism 708 described above with reference to FIG. 7.

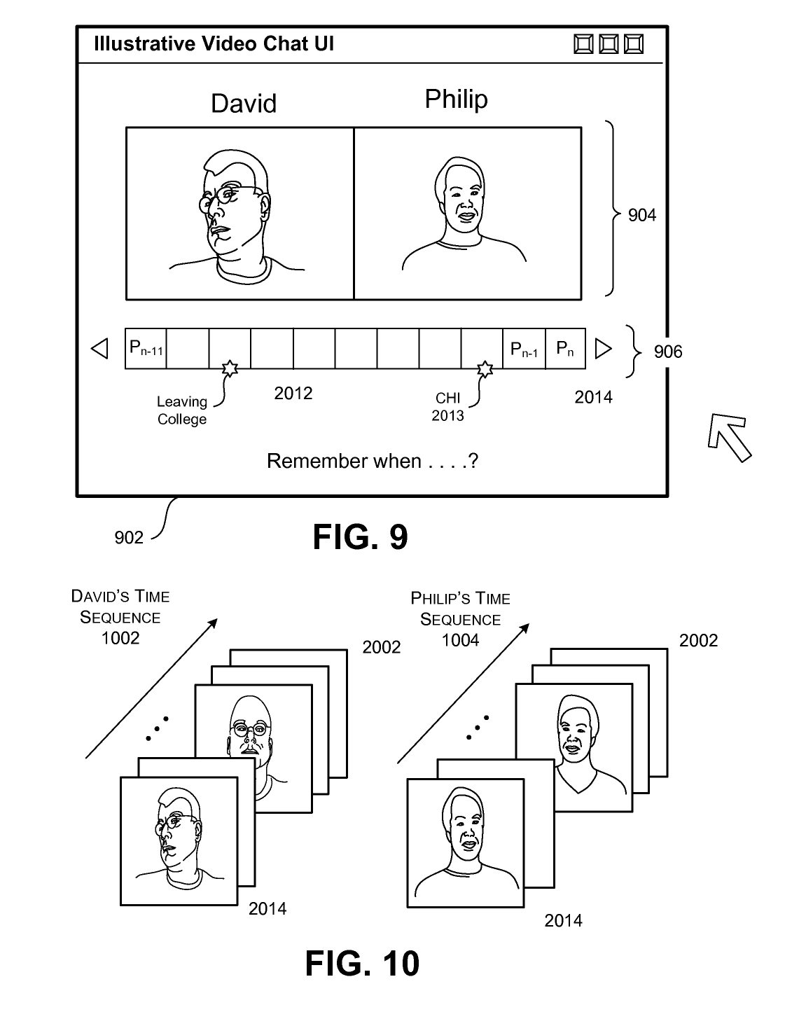

FIG. 9 shows a user interface presentation that the presentation processing component 124 presents in the context of a communication session between at least two users, named David and Philip. In the case of FIG. 9, the communication session corresponds to a video communication session provided by a video communication service. In other cases, the communication session may correspond to a voice-only (e.g., a VOIP) communication session, an instant messaging (IM) communication session, an Email communication session, or other text-based communication session, and so on.

In some cases, the MPS 102 may automatically invoke its service upon the start of any communication session. In other cases, the MPS 102 may automatically invoke its service for only some communication sessions, such as communication sessions that last longer than a prescribed conversation length, e.g., because the reminiscing fostered by the MPS 102 may be more desirable and useful in the context of longer calls. Further, the MPS 102 can allow any participant to control the triggering factors that will invoke the MPS service, or to disable the MPS service entirely. A user can make these selections via a configuration tool or the like. Further, upon the occurrence of each triggering event, the MPS 102 can optionally ask each participant to accept or decline the MPS service. In the example of FIG. 9, the input event that triggers the presentation of related media items corresponds to the initiation of a communication session between the two users. The MPS 102 can determine the identities of the two users based on login information provided by the two users, upon establishing the communication session.

Assume that the user “David” is interacting with a local version of the user interface presentation 902 (while “Philip” is interacting with another local version of the user interface presentation 902). The user interface presentation 902 that is presented to David may include a first section 904 that at least shows a real time video of the second user, Philip. Or the first section 904 may show a real time video of both David and Philip (as in the particular case of FIG. 9).

The user interface presentation 902 also includes a second section 906 which shows a collection of media items that are determined to be relevant to the communication session, arranged in any format. For example, the user interface presentation 902 arranges the media items in a timeline format. But the user interface presentation 902 could have alternatively used the collage format to present the media items, and/or some other format. In one case, the MPS 102 may draw the media items from a remote common data store, e.g., to which both David and Philip have previously uploaded their photo items. In another case, the MPS 102 may draw the media items that it presents to David from a local (or remote) personal data store associated with David, and draw the media items that it presents to Philip from a local (or remote) personal data store associated with Philip. David's data store may contain the same content as Philip's data store, or different content.

Further, regardless of where the media items originate, the set of media items that are presented to David may be the same as the set of media items that are presented to Philip, or different from the media items that are presented to Philip. For example, consider the scenario in which the MPS 102 draws from the personal data stores of David and Philip, where those data stores contain different photo items. The MPS 102 can present the most relevant photo items from David's data store for presentation to David, and present the most relevant photo items from Philip's data store for presentation to Philip, there being no expectation that the two sets of media items will be the same. Further, either David or Philip can optionally decide to share personal photo items with each other during their conversation. Or these users can configure the MPS service to automatically share the photo items. In the following explanation, however, assume that the MPS service presents the same collection of media items to both David and Philip.

In one case, the media items that are presented are considered relevant because they depict either the first user or the second user, or preferably both the first user and the second user. For example, the media items may include a collection of digital photographs taken by David or Philip which include both David and Philip. One such digital photograph may show these two friends on their graduation from college. Another such digital photograph may show these friends at a recent conference, and so on.

Alternatively, or in addition, the media items may correspond to media items captured by the video communication system itself. For example, the video communication system may have taken one or more snapshots and/or video clips (and/or audio clips) during each interaction session between David and Philip, over the course of many previous interactions between David and Philip.

FIG. 10, for example, shows a first series 1002 of media items that features the first user, David, taken over plural communication sessions with the second user, Philip. These media items are arranged in order of time, from least recent to most recent. Similarly, the figure shows a second series 1004 of media items that feature the second user, Philip, taken over the plural communication sessions with the first user, David, arranged in order of time. The user interface presentation 902 may display these sequences of media items in any manner, such as using the timeline format shown in FIG. 9. Alternatively, the user interface presentation 902 may provide a time lapse animation presentation of both series (1002, 1004) of media items, that is, by sequencing through the items in rapid succession when a user executes a play command. For example, the user interface presentation 902 may display the animated sequences in side-by-side relationship, e.g., the sequence for David occurring on the left side and the sequence for Philip occurring on the right side. The animated sequences may be enjoyable to both users, particularly in those cases in which one or more of the users undergoes a dramatic transition over the years (which may be most pronounced in the case of children). The sequences may also prompt powerful emotional responses in the users and/or cause the users to view their interactions in a new perspective; both consequences may enhance the interaction between the users.

In addition, the presentation processing component 124 can present the above-described media items to the two users (David and Philip) outside the context of their communication session. For example, the presentation processing component 124 can present the related media items to the users within a prescribed window of time, starting from the end of the communication session. Alternatively, the presentation processing component 124 can present the related media items only when some milestone has been reached, such as after determining that the users have been communicating with each other over a span of time that has reached some threshold, such as a three-year mark, etc.

In another case, the MPS 102 can detect the subject matter of the user's conversation in the current communication session, or over the course of two or more previous communication sessions. The MPS 102 can perform this task, for instance, based on extracting keywords from the users' speech, and/or based on explicit topic selections made by the users, and/or by based on implicit topic selections made by the users (e.g., when either David or Philip browses to a particular site in the course of the communication session), etc. The MPS 102 can then present media items that are most pertinent to the identified topic, while also depicting one or more of the users (David and Philip). For example, if one of the user's visits a football-related site, the MPS 102 can present digital photographs of David and Philip attending football games, if those photographs exist.

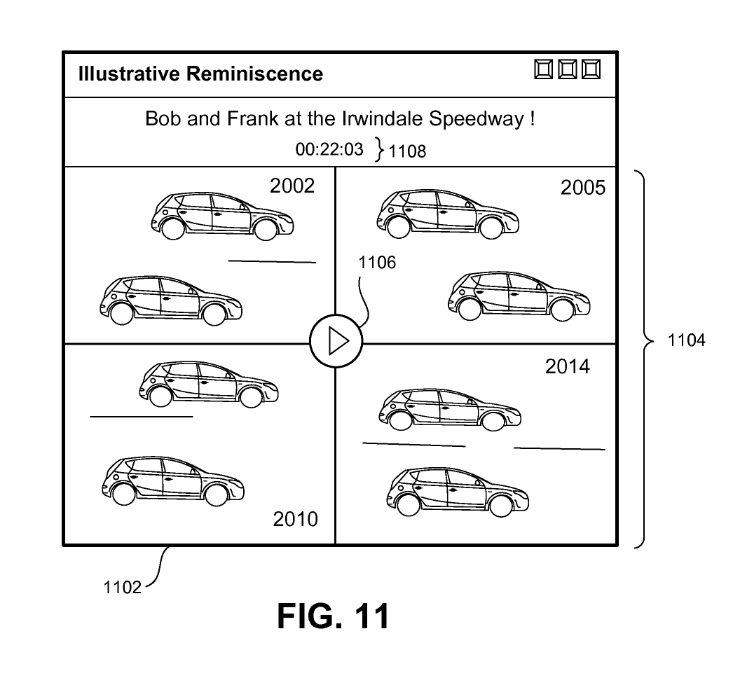

FIG. 11 shows a user interface presentation 1102 that is triggered upon: (a) determining that the user (Bob) is engaged in a particular activity, here, racing another user (Frank) in an annual race which occurs at a speedway in Southern California; and (b) determining that the user's current activity matches a similar activity that has occurred in the past. In this scenario, the previous pattern of user activity is established by the fact that these two users have raced at the same raceway several times over the years. In response to the above determinations, the user interface presentation 1102 presents video media items that capture the prior races between Bob and Frank.

More specifically, a section 1104 can devote plural sections for playing back plural video media items, each devoted to a separate race that has occurred in particular year. A start/stop control button 1106 allows the user to initiate the playback of all the video media items, simultaneously. The video media items are synchronized such that they play back in coordinated fashion, e.g., starting from a point in time at which the races begin. By virtue of this type of presentation, the user (Bob) can compare his performance over the years, e.g., by identifying trends in his performance. A timer 1108 may display the amount of time that has elapsed in the playback of the video media items.

B. Illustrative Processes

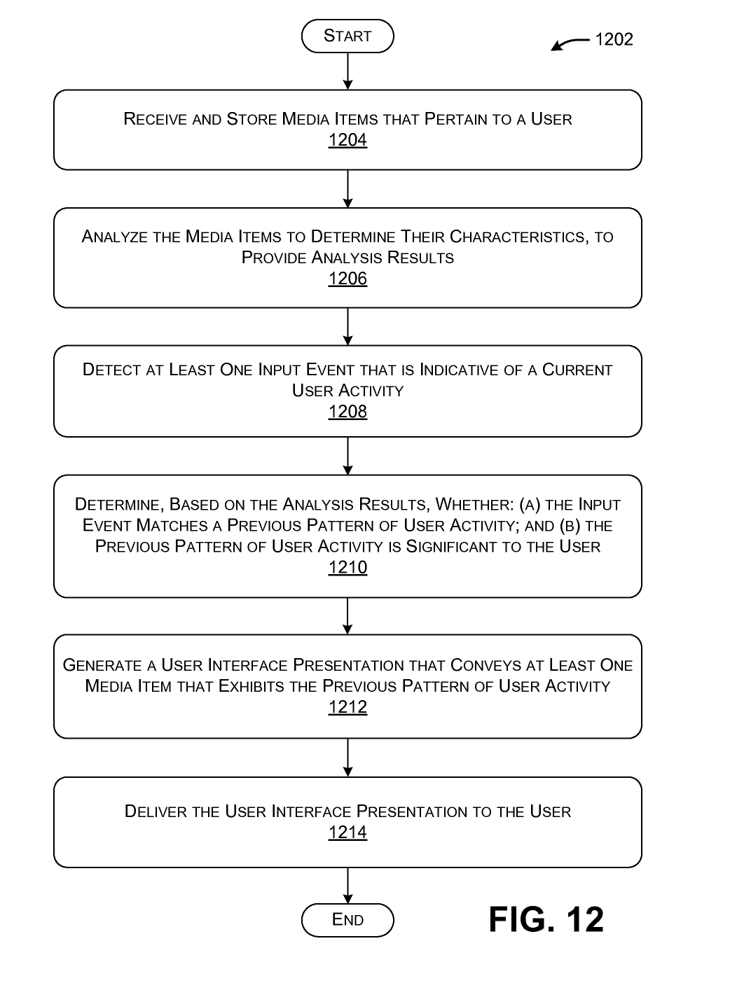

FIGS. 12-14 show procedures that explain one manner of operation of the Media Presentation System (MPS) 102 of Section A. Since the principles underlying the operation of the MPS 102 have already been described in Section A, certain operations will be addressed in summary fashion in this section.

Starting with FIG. 12, this figure show a process 1202 that represents an overview of one manner of operation of the MPS 102. In block 1204, the MPS 102 receives and stores a plurality of media items pertaining to a user over a span of time. In block 1206, the MPS 102 analyzes the media items to determine characteristics of the media items, to provide analysis results. In block 1208, the MPS 102 detects at least one input event that is indicative of a current user activity. In block 1210, the MPS 102 determines, based on the analysis results, whether: (a) the input event matches a previous pattern of user activity that is exhibited by the media items; and (b) the previous pattern of user activity is significant, based on one or more significance-based considerations. If the test in block 1210 is met, then, in block 1212, the MPS 102 generates a user interface presentation that conveys at least one media item that exhibits the previous pattern of user activity. In block 1214, the MPS 102 delivers, using a delivery framework (such as a video communication system), the user interface presentation to a user computing device, for consumption by the user. In some cases, the user computing device may correspond to a smartphone or other portable computing device.

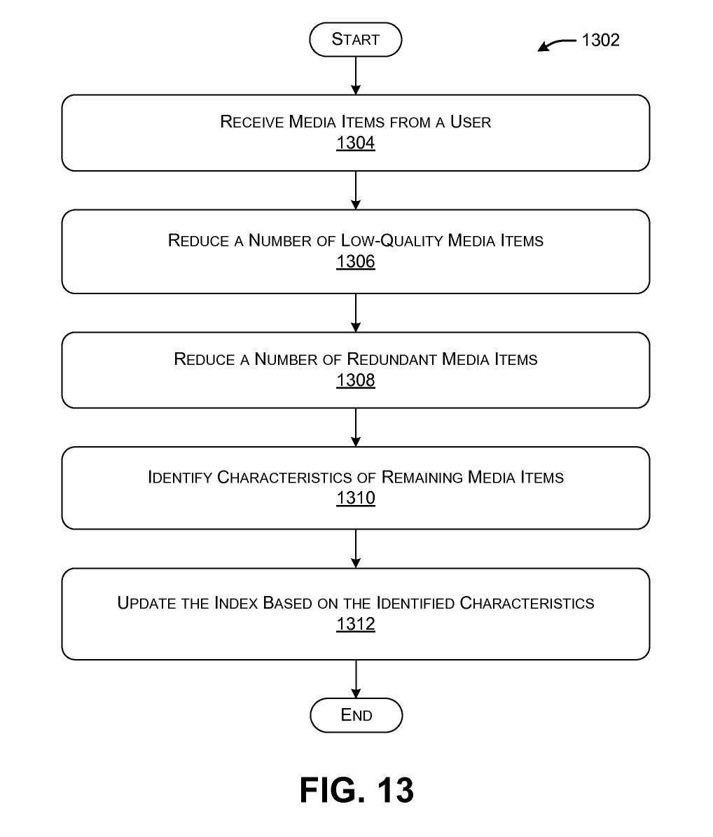

FIG. 13 describes one manner of operation of the media analysis component 116 of the MPS 102. In block 1304, the media analysis component 116 receives a set of original media items from a user. In block 1306, the media analysis component 116 reduces a number of low-quality media items, e.g., by removing blurred media items, off-center media items, etc. in the set of original media items. In block 1308, the media analysis component 116 reduces a number of redundant media items. In block 1310, the media analysis component 116 can identify characteristics of the remaining media items. In block 1312, the media analysis component 116 can update the index based on the characteristics identified in block 1312.

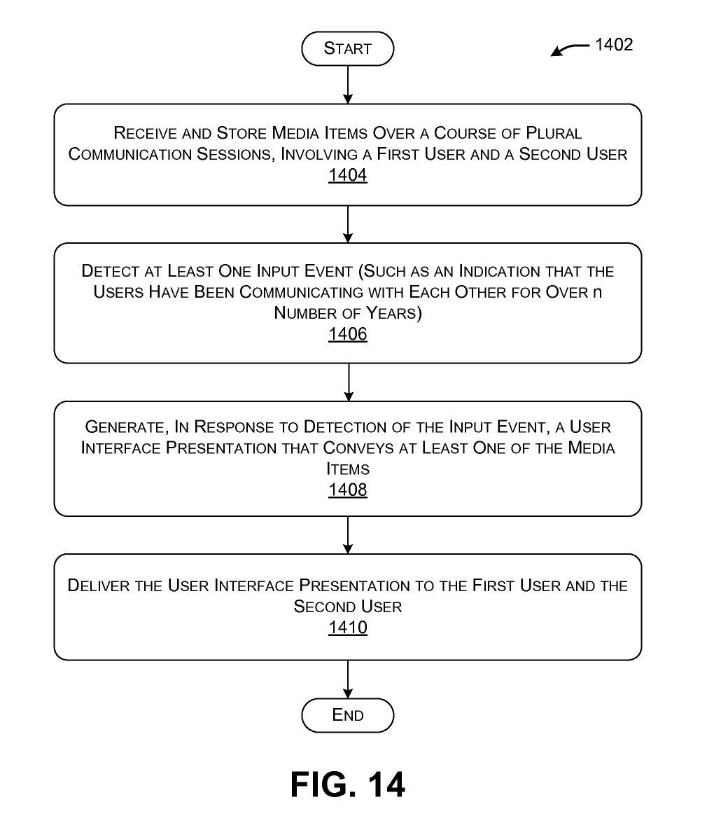

FIG. 14 shows a procedure 1402 that describes one manner by which the MPS 102 may interact with a communication system. In block 1404, the MPS 102 receives and stores a plurality of media items collected over a course of plural communication sessions involving at least a first user and a second user. Each media item depicts the first user and/or the second user while engaging in a particular communication session. In block 1406, the MPS 102 detects at least one input event. The input event may correspond to an indication that the users have been communicating with each other longer than a prescribed amount of time, such as n number of years. In block 1408, the MPS 102 generates, in response to the detection of the input event, a user interface presentation that conveys at least one of the media items. In block 1410, the MPS 102 delivers the user interface presentation to the first user and/or the second user. More specifically, the MPS 102 can deliver the interface presentation within the context of a current communication session, or outside the context of a communication session.

C. Illustrative Computing Functionality

FIG. 15 shows computing functionality 1502 that can be used to implement any aspect of MPS 102 of FIG. 1. For instance, the type of computing functionality 1502 shown in FIG. 15 can be used to implement any aspect of the local computing functionality (202, 302) of FIGS. 2 and 3, and/or the remote computing functionality 304 of FIG. 3. In all cases, the computing functionality 1502 represents one or more physical and tangible processing mechanisms.

The computing functionality 1502 can include one or more processing devices 1504, such as one or more central processing units (CPUs), and/or one or more graphical processing units (GPUs), and so on.

The computing functionality 1502 can also include any storage resources 1506 for storing any kind of information, such as code, settings, data, etc. Without limitation, for instance, the storage resources 1506 may include any of: RAM of any type(s), ROM of any type(s), flash devices, hard disks, optical disks, and so on. More generally, any storage resource can use any technology for storing information. Further, any storage resource may provide volatile or non-volatile retention of information. Further, any storage resource may represent a fixed or removable component of the computing functionality 1502. The computing functionality 1502 may perform any of the functions described above when the processing devices 1504 carry out instructions stored in any storage resource or combination of storage resources.

As to terminology, any of the storage resources 1506, or any combination of the storage resources 1506, may be regarded as a computer readable medium. In many cases, a computer readable medium represents some form of physical and tangible entity. The term computer readable medium also encompasses propagated signals, e.g., transmitted or received via physical conduit and/or air or other wireless medium, etc. However, the specific terms “computer readable storage medium” and “computer readable medium device” expressly exclude propagated signals per se, while including all other forms of computer readable media.

The computing functionality 1502 also includes one or more drive mechanisms 1508 for interacting with any storage resource, such as a hard disk drive mechanism, an optical disk drive mechanism, and so on.

The computing functionality 1502 also includes an input/output module 1510 for receiving various inputs (via input devices 1512), and for providing various outputs (via output devices 1514). The input devices 1512 can include any of key entry devices, mouse entry devices, touch-enabled entry devices, voice entry devices, and so on. One particular output mechanism may include a presentation device 1516 and an associated graphical user interface (GUI) 1518. The computing functionality 1502 can also include one or more network interfaces 1520 for exchanging data with other devices via one or more networks 1522. One or more communication buses 1524 communicatively couple the above-described components together.

The network(s) 1522 can be implemented in any manner, e.g., by a local area network, a wide area network (e.g., the Internet), point-to-point connections, etc., or any combination thereof. The network(s) 1522 can include any combination of hardwired links, wireless links, routers, gateway functionality, name servers, etc., governed by any protocol or combination of protocols.

Alternatively, or in addition, any of the functions described in the preceding sections can be performed, at least in part, by one or more hardware logic components. For example, without limitation, the computing functionality 1502 can be implemented using one or more of: Field-programmable Gate Arrays (FPGAs); Application-specific Integrated Circuits (ASICs); Application-specific Standard Products (ASSPs); System-on-a-chip systems (SOCs); Complex Programmable Logic Devices (CPLDs), etc.

In closing, the functionality described above can employ various mechanisms to ensure the privacy of user data maintained by the functionality, in accordance with user expectations and applicable laws of relevant jurisdictions. For example, the functionality can allow a user to expressly opt in to (and then expressly opt out of) the provisions of the functionality. The functionality can also provide suitable security mechanisms to ensure the privacy of the user data (such as data-sanitizing mechanisms, encryption mechanisms, password-protection mechanisms, etc.).

Further, the description may have described various concepts in the context of illustrative challenges or problems. This manner of explanation does not constitute a representation that others have appreciated and/or articulated the challenges or problems in the manner specified herein. Further, the claimed subject matter is not limited to implementations that solve any or all of the noted challenges/problems.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, performed by one or more computing devices, for providing at least one media item that is related to a current activity of a user, comprising:
receiving and storing a plurality of media items pertaining to the user over a span of time;
analyzing the media items to determine characteristics of the media items, to provide analysis results;
detecting at least one input event that is indicative of a current user activity;
determining, based on at least the analysis results, that: (a) the input event matches a previous pattern of user activity that is exhibited by the media items; and (b) the previous pattern of user activity is significant to the user, based on one or more significance-based considerations;
generating a user interface presentation that conveys at least one media item that exhibits the previous pattern of user activity; and
delivering the user interface presentation to a user computing device, for consumption by the user.

2. The method of claim 1, wherein at least some of the plurality of media items that are received are digital photographs.

3. The method of claim 1, wherein at least some of the plurality of media items that are received are digital videos.

4. The method of claim 1, wherein said analyzing further comprises updating an index based on the characteristics of the plurality of media items.

5. The method of claim 4, wherein said updating is preceded by:
reducing a number of media items in the plurality of media items that do not meet one or more quality-based considerations; and
reducing a number of media items in the plurality of media items that contain similar content.

6. The method of claim 1, wherein the input event indicates that the user is near a specified date.

7. The method of claim 1, wherein the input event indicates that the user has uploaded one or more media items pertaining to a particular location.

8. The method of claim 1, wherein the input event indicates that the user is interacting with another user via a communication system.

9. The method of claim 8, wherein the communication system is a video communication system.

10. The method of claim 1, wherein the user interface presentation provides a collection of media items that pertain to the previous pattern of user activity in a timeline format.

11. The method of claim 1, wherein the user interface presentation provides a collection of media items that pertain to the previous pattern of user activity in a collage format.

12. The method of claim 1, wherein the user interface presentation provides a time lapse animated sequence of media items that pertain to the previous pattern of user activity over a span of time, arranged in temporal order.

13. The method of claim 12, wherein the user interface presentation includes a first time lapse animated sequence that shows the user over the span of time, and a second time lapse animated sequence that shows another user over the span of time, with whom the user has communicated in one or more previous communication sessions.

14. The method of claim 1,
wherein said generating includes synchronizing two or more video media items that pertain to the previous pattern of user activity, and
wherein the user interface presentation provides a synchronized presentation of said two or more video media items.

15. The method of claim 1, further comprising:
determining an explicit or implicit evaluation of said at least one media item by the user, to provide feedback information; and
modifying one or more of said detecting, determining, generating, and/or delivering, based on the feedback information.

16. The method of claim 1, further comprising sharing said at least one media item with another person, upon instruction by the user.

17. A computer readable storage medium for storing computer readable instructions, the computer readable instructions performing a method, when executed by one or more processing devices, the method comprising:
receiving and storing a plurality of media items collected over a course of plural communication sessions involving at least a first user and a second user, each media item depicting the first user and/or the second user while engaging in a particular communication session;
detecting at least one input event; and
generating, in response to said detecting, a user interface presentation that conveys at least one of the media items; and
delivering the user interface presentation to the first user and/or the second user.

18. The computer readable storage medium of claim 17, wherein said at least one of the media items comprises a time lapse animated sequence of a collection of media items.

19. The computer readable storage medium of claim 17, wherein the input event corresponds to a determination that the first user and the second user have been interacting with each other longer than a prescribed amount of time.

20. A media presentation system, implemented by one or more computing devices, comprising:
a receiving component configured to receive and store a plurality of media items over a span of time that pertain to interaction between at least a first user and a second user;
a media analysis component configured to analyze the media items to determine characteristics of the media items, to provide analysis results;
an event detection component configured to detect that the first user is engaged in a current communication session with the second user; and
a presentation processing component configured to generate, based on an output of the event detection component and the analysis results, a user interface presentation that conveys at least one media item that pertains to both the first user and the second user,
the user interface presentation being provided to a delivery framework, for delivery to both the first user and the second user in a course of the current communication session.
